(19) United States
(12) Patent Application Publication
(10) Pub. No.: US 2024/0287269 A1
(43) Pub. Date: Aug. 29, 2024

(54) SYNTHESIS OF POLY(PHENYLENE) COMPOUND INTERGRATED WITH FUNCTIONALIZED FLUORENE PORTION FOR ION EXCHANGE IONOMER AND ION EXCHANGE IONOMER

(71) Applicant: USA Fortescue IP, Inc., Wilmington, DE (US)

(72) Inventors: Qiuying Zhang, Fairfax, VA (US); Bamdad Bahar, Georgetown, DE (US); Mengjie Chen, Seaford, DE (US)

(21) Appl. No.: 18/636,014

(22) Filed: Apr. 15, 2024

Related U.S. Application Data
(63) Continuation-in-part of application No. PCT/US22/48352, filed on Oct. 31, 2022.
(60) Provisional application No. 63/274,621, filed on Nov. 2, 2021.
(60) Provisional application No. 63/459,190, filed on Apr. 13, 2023.
(60) Provisional application No. 63/459,189, filed on Apr. 13, 2023.

(51) Int. Cl. C08J 5/22; C08G 61/10; C08K 3/014; C08K 3/04; C08K 5/00; C08K 5/02; C08K 5/17

(52) U.S. Cl. CPC C08J 5/2293; C08G 61/10; C08K 3/014; C08K 3/04; C08K 5/005; C08K 5/02; C08K 5/17; C08G 2261/1412; C08G 2261/143; C08G 2261/146; C08G 2261/3142; C08J 2365/02

(57) ABSTRACT

An ion exchange polymer has an ionomer structure containing poly(phenylene) compound integrated with functionalized poly(fluorene). The ion conducting co-polymer includes a poly(fluorene) compound and a poly(phenylene) compound covalently bonded together. The poly(fluorene) compound has a 9H-fluorene structure that is a polycyclic aromatic hydrocarbon having a center ring with five carbon atoms, and a benzene ring on each of opposing sides of said center ring. The poly(phenylene) compound is covalently bonded to each of the pair of benzene rings of the poly(fluorene) compound. A pair of sidechains extends from the center ring of the poly(fluorene) compound to a respective terminal group. The terminal groups are configured on sidechains of the poly(fluorene) compound and can be converted into functional groups such as quaternary ammonium or n-methyl piperidine functional groups. The ion exchange polymer may include a porous scaffold support.

### CROSS REFERENCE TO RELATED APPLICATIONS

This application is a continuation in part of international application No. PCT/US22/48352 filed on Oct. 31, 2022, which claims the benefit of priority to U.S. provisional patent application No. 63/274,621, filed on Nov. 2, 2021; also, this application claims the benefit of priority to U.S. provisional patent application No. 63/459,190, filed on Apr. 13, 2023 and to U.S. provisional patent application No. 63/459,189, filed on Apr. 13, 2023; the entirety of each prior application is hereby incorporated by reference herein.

### BACKGROUND OF THE INVENTION

### Field of the Invention

This application is directed to a functionalized ion exchange co-polymer structure with poly(phenylene) and poly(fluorene) compounds and a co-polymer of co-poly(phenylene-fluorene) that is ion pair acid doped and covalently acid doped for improved ion exchange.

### Background

In the recent years, proton exchange membrane fuel cells including solid polymer membrane as the electrolyte has been widely studied due to their high efficiency and density as well as low start temperature. However, the use of noble metal catalysts such as platinum has been an obstacle of viable commercialization of proton exchange membrane fuel cells. Also, high pH condition is a significant requirement for alkaline membrane fuel cells, which limits the utilization of proton exchange membrane. Therefore, the interest of developing ion exchange membranes (AEM) for alkaline fuel cells has prominently grown due to the low overpotentials caused by electrochemical reactions at alkaline environment and the dispensation of noble metal catalysts. A good ion exchange membrane for alkaline fuel cells should be with necessary conductivity, chemical and mechanical stability. Moreover, low cost is another significant requirement of developing new ion exchange membranes. For example, a well-known cation exchange membrane (Nafion) developed by DuPont contributes up to 40% of the total cost of some redox flow batteries. Hence, the high cost rendered people to seek more cheaper alternatives, primarily ion exchange membranes. Up to now, most commercially available ion exchange membranes are based on cross-linked polystyrene, which are not chemically stable in alkaline environments. Some other aryl ether-containing polymer backbones of ion exchange membranes tend to be attacked by hydroxide ions, which causes the degradation of the polymers. As a result, developing aryl ether-free polyphenylene-based ionomers employing stable cationic groups is a promising direction for ion exchange membrane (AEM) fuel cell. Poly(phenylene)s and their derivatives have received many attentions because of their good performance on thermal, mechanical, and electrochemical properties. However, the lower solubility of the growing rigid rod chains in the process of polymerization of poly(phenylene)s causes the low molecular weight. In order to overcome the issue, researchers tried to introduce pendent sidechains to the phenyl rings and successfully improved the solubility of poly(phenylene)s. It should be noted that poly(phenylene)s is a kind of conjugated polymer which is promising in the application of biosensors research. To use those kind of polymer materials in biological applications, introducing appropriate sidechains to poly(phenylene) compounds and render them soluble in water and other polar solvents is critically necessary.

AEMs are generally made up of ionomers with pendant cationic groups such as benzyl trimethylammonium (BTMA) which is most commonly used, sulfonate and carboxylate etc. Hibbs et. al have applied BTMA cations for attaching to polymer backbones. Many BTMA-containing AEMs developed by them showed excellent properties and chemical stability. For example, the ion exchange capacity of a perfluorinated AEM with BTMA decreased less than 5% after 233-hour test at 50° C. Moreover, some BTMA-containing membranes can bear high temperature over 60° C. and keep chemical stability without thermal-degradation. Hence, the investigation and development of more chemically stable sidechains are becoming a considerable direction of enhancing ion exchange membrane (AEM) fuel cell.

### SUMMARY OF THE INVENTION

The present invention provides an ion conducting co-polymer and a composite ion conducting membrane that may include a porous scaffold support for said ion conducting co-polymer. The ion conducting co-polymer includes a poly(fluorene) compound and a poly(phenylene) compound covalently bonded together. The poly(fluorene) compound has a 9H-fluorene structure that is a polycyclic aromatic hydrocarbon having a center ring with five carbon atoms, and a benzene ring on each of opposing sides of said center ring. The poly(phenylene) compound is covalently bonded to each of the pair of benzene rings of the poly(fluorene) compound. A pair of sidechains extends from the center ring of the poly(fluorene) compound to a respective terminal group. The terminal groups are configured on sidechains of the poly(fluorene) compound and can be converted into functional groups such as quaternary ammonium or n-methyl piperidine functional groups. The quaternary ammonium may be exchanged with phosphonic acid groups, another type of functional group.

The starting ion conducting co-polymer includes a poly(fluorene) compound and a poly(phenylene) compound covalently bonded together. The poly(fluorene) compound has a 9H-fluorene structure that is a polycyclic aromatic hydrocarbon having a center ring with five carbon atoms, and a benzene ring on each of opposing sides of said center ring. The poly(phenylene) compound is covalently bonded to each of the pair of benzene rings of the poly(fluorene) compound. A pair of sidechains extends from the center ring of the poly(fluorene) compound to a respective terminal group. The terminal groups are configured on sidechains of the poly(fluorene) compound and can be converted into functional groups such as quaternary ammonium or n-methyl piperidine functional groups. The functional groups can be doped by phosphoric acid to form ion pairs enabling conducting protons and anions simultaneously. The ion exchange polymer and ion exchange membrane described herein may be an anion and/or cation exchange or conducting polymer or membrane.

Exemplary poly(phenylene)-poly(fluorene) ion exchange co-polymer may have functional groups selected from the group of quaternary ammoniums, n-methyl piperidine, tertiary diamines, phosphonium, benz(imidazolium), sulphonium, guanidinium, metal cations, pyridinium. Preferably the functional group is quaternary ammonium or n-methyl piperidine.

An exemplary porous scaffold support may be made from polymer group consisting of polyolefins, polyamides, polycarbonates, cellulosics, polyacrylates, copolyether esters, polyamides, polyarylether ketones, polysulfones, polybenzimidazoles, fluoropolymers, and chlorinated polymers.

The aromatic arone monomer consists of benzene aromatic rings that are branched. This branching makes the monomer and resulting ion exchange co-polymer more thermally stable and mechanically durable.

The poly(fluorene) compound may be a polycyclic aromatic with a center with five carbons and two benzene rings on either side of said center ring. The compound has a pair of sidechains that each extend to a respective terminal group, such as bromine, which can be functionalized with a functional group (Fn), such as quaternary ammonium or n-methyl piperidine and/or phosphonate group. group.

### Sidechain

The sidechains of any of the ion conducting co-polymers described herein, may be hydrocarbon and may have four or more carbons, six or more carbons, eight or more, 10 or more, 15 or more, or even about 20, or any other range between and including the number of carbons provided. carbons and any range between and including the number carbons listed. A longer sidechain may provide high ion conductivity as the functional groups responsible for ion conduction may be more mobile. A longer sidechain may provide high ionic conductivity as the functional groups responsible for ionic conduction may be more mobile.

### Functional Group

Exemplary poly(phenylene)-poly(fluorene) ion exchange co-polymer may have functional groups selected from the group of quaternary ammoniums, n-methyl piperidine, tertiary diamines, phosphonium, benz(imidazolium), sulphonium, guanidinium, metal cations, pyridinium. Preferably the functional group is quaternary ammonium or n-methyl piperidine because quaternary ammonium has proven to effectively exchange with phosphoric acid during doping to produce the ion pair.

Exemplary poly(phenylene)-poly(fluorene) ion exchange co-polymer may have functional groups selected from the group of quaternary ammoniums, n-methyl piperidine, tertiary diamines, phosphonium, benz(imidazolium), sulphonium, guanidinium, metal cations, pyridinium. Preferably the functional group is quaternary ammonium or n-methyl piperidine or phosphate.

### Doping

The polyphenylene-poly(fluorene) co-polymer ion exchange polymer may be acid doped with phosphoric acid to produce an ion paired phosphoric acid doped ion exchange polymer, where the phosphonic acid groups are ionically bonded. The present invention provides a phosphoric acid doped ion-pair proton and ion conducting co-polymer and a composite proton and ion conducting membrane that may include a porous scaffold support. The weight percent of phosphoric acid used for doping the starting ion exchange membrane may be about 5% or more, about 50% or more, about 70% or more, about 80% or more, and any range between and including the percentages provide. The higher concentrations are preferred as they more quickly and effectively initiate the exchange for creating the ion pair.

Also, triethyl phosphite may be used to functionalize the precursor co-polymer to produce phosphate ion exchange polymer, wherein the phosphate is covalently bonded to the side chains of the polyphenylene-poly(fluorene) co-polymer ion exchange polymer. Exemplary poly(phenylene)-based co-polymer may have organic phosphate functional groups.

### Additives

Exemplary polyphenylene-poly(fluorene) ion exchange co-polymer may have additive selected from a group consisting of radical scavengers, plasticizers, fillers, ion conducting material, crosslinking agent.

Exemplary polyphenylene-poly(fluorene) phosphate-based ion pair exchange co-polymer may have additive selected from a group consisting of radical scavengers, plasticizers, fillers, ion conducting material, crosslinking agent, ion pair reagent.

The polyphenylene-poly(fluorene) co-polymers integrated with functionalized fluorene molecules are further described below in reference to the structures. Carbon-carbon coupling polymerizations such as has been successfully used to synthesize poly(phenylene)s, is costly and strict to the environment of storing palladium-containing catalysts. In the present invention, a catalyst-free Diels-Alder polycondensation reaction for the synthesis of the co-polymer mixtures may be used, which is thermodynamicly driven, which comprises:
an aromatic arone monomer having the structure (1):

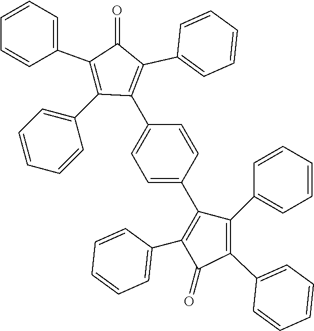 [SMILES: O=C1C(c2ccccc2)=C(c2ccccc2)C(c2ccc(C3=C(c4ccccc4)C(=O)C(c4ccccc4)=C3c3ccccc3)cc2)=C1c1ccccc1]

a 9,9-Bis(6-bromohexyl)-2,7-diethynyl-9H-fluorene monomer having the structure (2)

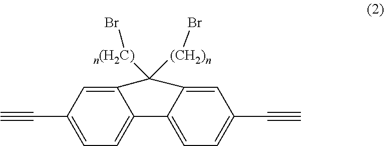

wherein:
n is in the range of 1-6

The ion exchange co-polymers having the formula (1):

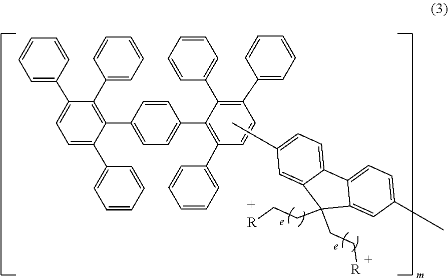

wherein:
R is selected from

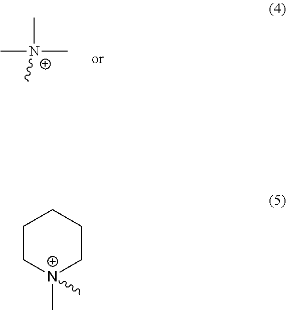

wherein (4) is trimethyl-ammonium (TMA) and (5) piperidinium.

The starting hydroxide exchange co-polymers are synthesized which comprises ether free functionalized polyphenylene compounds integrated with functionalized poly(fluorene).

The hydroxide exchange co-polymers are synthesized which comprises ether free functionalized polyphenylene compounds integrated with functionalized poly(fluorene). The water uptake, IEC and conductivity.

A method of synthesizing the ion exchange co-polymers shown in Formula (1) is described below, which comprises reacting monomers shown in structures (1) & (2) in organic solvent to form neutral intermediate polymers; quaternization of the neutral intermediate polymer in organic solvent to form ionic polymer; dissolvent the ionic polymer in organic solvent for solution-casting membranes; the membrane is immersed in base solution for ion exchange to form hydroxide exchange membrane.

The polyphenylene-poly(fluorene) co-polymers may include the polyphenylene that consists of aromatic rings, benzene rings, without any aliphatic hydrocarbon chains which are more susceptible to chemical attach and are not as thermally stable. The polyphenylene of the polyphenylene-poly(fluorene) co-polymer may be branched aromatics, further improving mechanical and thermal properties of the polyphenylene-poly(fluorene) co-polymer.

The present invention provides a covalent phosphate-based ion-pair ion exchange co-polymer and a composite proton and ion conducting membrane that may include a porous scaffold support. The polyphenylene polymers integrated with phosphate functionalized fluorene molecules are presented in this embodiment. Carbon-carbon coupling polymerizations such as has been successfully used to synthesize poly(phenylene)s, is costly and strict to the environment of storing palladium-containing catalysts. In the present invention the precursor polymer is synthesized by a catalyst-free Diels-Alder polycondensation reaction is used for covalently phosphoric acid ion pair. The starting co-polymers are synthesized which comprises ether free functionalized polyphenylene compounds integrated with functionalized side chains.

A method of synthesizing the starting co-polymers shown in FIG. 1) is described below to form neutral intermediate polymers; Functionalization of the neutral intermediate polymer in organic solvent to form ion pair polymer; dissolvent the ionic polymer in organic solvent for solution-casting membranes.

Exemplary poly(phenylene)-poly(fluorene) ion exchange co-polymer may have functional groups selected from the group of quaternary ammoniums, n-methyl piperidine, tertiary diamines, phosphonium, benz(imidazolium), sulphonium, guanidinium, metal cations, pyridinium. Preferably the functional group is quaternary ammonium or n-methyl piperidine.

Exemplary polyphenylene-poly(fluorene) ion exchange co-polymer may have additive selected from a group consisting of radical scavengers, plasticizers, fillers, ion conducting material, crosslinking agent, ion pair reagent.

The present invention provides a phosphoric doped ion-pair ion exchange membrane comprising a functional polymer based on a poly(phenylene)-poly(fluorene) co-structure with quaternary ammonium functional groups which may be mechanically reinforced by a porous support, or porous scaffold support for reinforcement. Typically, the starting ion exchange membrane is prepared by imbibing the porous scaffold support with a polymer solution of a non-ionic precursor polymer followed by conversion of a functional moiety on the polymer to form a trimethyl ammonium cation. Such a conversion can be accomplished by treatment of the precursor polymer membrane with trimethylamine. In addition, an optional chemical crosslinking reaction can also be used to toughen the polymer by converting it from a thermoplastic to a thermoset material. Such a conversion can be accomplished by treatment of the precursor polymer membrane by a diamine, which is typically performed before the amination reaction. Typically, the thickness of the functionalized membrane is 25 micrometers or less, more typically 10 micrometers or less, and in some embodiments 5 micrometers or less.

The polyphenylene polymers integrated with phosphate functionalized fluorene molecules are presented in this embodiment. Carbon-carbon coupling polymerizations such as has been successfully used to synthesize poly(phenylene)s, is costly and strict to the environment of storing palladium-containing catalysts. In the present invention the co-polymer is synthesized by a catalyst-free Diels-Alder polycondensation reaction.

A method of synthesizing the starting co-polymers is described below to form neutral intermediate polymers; Functionalization of the neutral intermediate polymer in organic solvent to form ion pair polymer; dissolvent the ionic polymer in organic solvent for solution-casting membranes.

A support layer, such as a porous scaffold support, such as a porous membrane may be incorporated into a phosphate-based ion exchange membrane for reinforcement. Typically, the phosphate-based ion exchange membrane is prepared by imbibing the porous support layer with phosphate-based ion exchange polymer solution of a non-ionic precursor polymer followed by conversion of a functional moiety on the polymer to form organic phosphate group. Such a conversion can be accomplished by treatment of the precursor ion exchange membrane with Michaelis-Arbuzov Reaction. An ion exchange membrane may be prepared by imbibing the porous support layer with an ion exchange polymer solution of a non-ionic precursor polymer followed by conversion of a functional moiety on the polymer to form quaternary ammonium or n-methyl piperidine cation. Such a conversion can be accomplished by treatment of the precursor ion exchange membrane with basic trimethylamine or aqueous solution or N-Methylpiperidine DMSO solution. An ion exchange membrane may be prepared by imbibing the porous support layer with a polymer solution of a non-ionic precursor polymer followed by conversion of a functional moiety on the polymer to form a trimethyl ammonium cation. Such a conversion can be accomplished by treatment of the precursor polymer membrane with trimethylamine. In addition, an optional chemical crosslinking reaction can also be used to toughen the polymer by converting it from a thermoplastic to a thermoset material. Such a conversion can be accomplished by treatment of the precursor polymer membrane by a diamine, which is typically performed before the amination reaction.

The thickness of the phosphate-based ion pair exchange membrane, or ion exchange membrane, may be preferably very thin, such about 200 μm or less, about 100 μm or less about 50 μm or less, about 25 μm or less, about 10 μm or less, about 5 μm or less, and in some embodiments about 5 micrometers or less. The ion exchange membrane may include a support layer as well at the listed thicknesses.

An exemplary support layer may be made from polymer group consisting of polyolefins, polyamides, polycarbonates, cellulosics, polyacrylates, copolyether esters, polyamides, polyarylether ketones, polysulfones, polybenzimidazoles, fluoropolymers, and chlorinated polymers.

The support layer may be a microporous support layer having an average or mean flow pore size of less than 1 micron as determined by a Capillary Flow Porometer, available from Porous Materials, Inc. Ithaca, NY, and the mean flow pore size may be about 0.5 microns or less, or even about 0.25 microns or less. A porous scaffold may be a porous fluoropolymer, such as expanded polytetrafluoroethylene (ePTFE), or a porous olefin, such as polyethylene and preferably high molecular polyethylene that may be oriented, such as a porous polyethylene and the like.

The polyphenylene-poly(fluorene) co-polymers integrated with phosphate functionalized fluorene molecules are presented in this embodiment. Carbon-carbon coupling polymerizations such as has been successfully used to synthesize poly(phenylene)s, is costly and strict to the environment of storing palladium-containing catalysts. In the present invention a catalyst-free Diels-Alder polycondensation reaction for the synthesis of the co-polymer mixtures is used.

The starting co-polymers are synthesized which comprises ether free functionalized polyphenylene compounds integrated with functionalized poly(fluorene).

Determination of the polymer structure is preferably conducted through NMR analysis and the molecular weight of the polymer is preferably conducted through Gel Permeation Chromatography.

The summary of the invention is provided as a general introduction to some of the embodiments of the invention and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows an embodiment of ion conducting co-polymer with poly(phenylene) compound covalently bonded to a poly(fluorene) compound and with functionalized terminal groups on the side chains of the poly(fluorene) compound.

FIG. 2 shows an embodiment of a reaction sequence for synthesizing the ion conducting co-polymer.

FIG. 3 shows the structure of the co-polyphenylene.

FIG. 4 shows the synthetic route for co-poly-phenylene.

FIG. 5 shows an embodiment of ion pair acid doping route for the phosphorylation of co-poly-phenylene.

FIG. 6 shows the synthetic route for co-poly-phenylene.

FIG. 7 shows an embodiment of ion pair acid doping route for the phosphorylation of co-poly-phenylene.

FIG. 8 shows the general structure of ion pair phosphoric acid-doping co-poly(phenylene-fluorene.

FIG. 9 shows the synthetic route of the starting materials for synthesizing co-poly(phenylene-fluorene.

FIG. 10 shows covalent phosphoric acid-doping route of conductive co-poly(phenylene-fluorene).

FIG. 11 shows covalent phosphoric acid-doping route of conductive co-poly(phenylene-fluorene).

FIG. 12 shows cross-sectional view of an exemplary ion exchange membrane comprising a thin sheet, less than 200 μm thick of ion exchange polymer.

FIG. 13 shows cross-sectional view of an exemplary porous reinforced support having a porous structure and pores therein, wherein the ion exchange polymer substantially fills the pores of the scaffold support.

FIG. 14 shows a cross-sectional view of an exemplary ultra-thin composite ion exchange polymer film having a layer of ion exchange polymer on either side of the porous reinforced support.

FIG. 15 shows cross-sectional view of an exemplary ultra-thin composite ion exchange polymer film formed by imbibing ion exchange polymer copolymer into a porous reinforced support using solution casting process, wherein the ion exchange polymer substantially fills the pores of the reinforced support.

FIG. 16 shows cross-sectional view of an exemplary membrane electrode assembly comprising a composite ion exchange membrane with a cathode on a first side and an anode on a second side.

Corresponding reference characters indicate corresponding parts throughout the several views of the figures. The figures represent an illustration of some of the embodiments of the present invention and are not to be construed as limiting the scope of the invention in any manner. Some of the figures may not show all of the features and components of the invention for ease of illustration, but it is to be understood that where possible, features and components from one figure may be an included in the other figures. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations, and improvements of the described embodiments, will occur to those skilled in the art and all such alternate embodiments, combinations, modifications, improvements are within the scope of the present invention.

According to one embodiment, a synthetic route and a composition are disclosed. The composition shown in Formula I includes the co-polymer structures with poly(phenylene) compounds integrated with functionalized poly(fluorene) compound. Where n is selected from 1-6 and R is selected from trimethylamine or N-methylpiperidine.

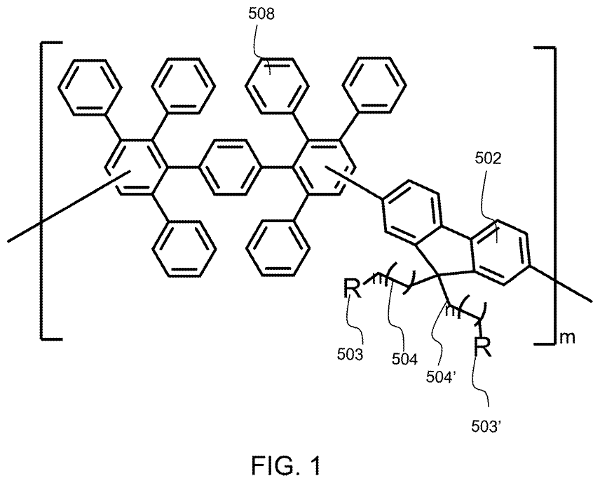

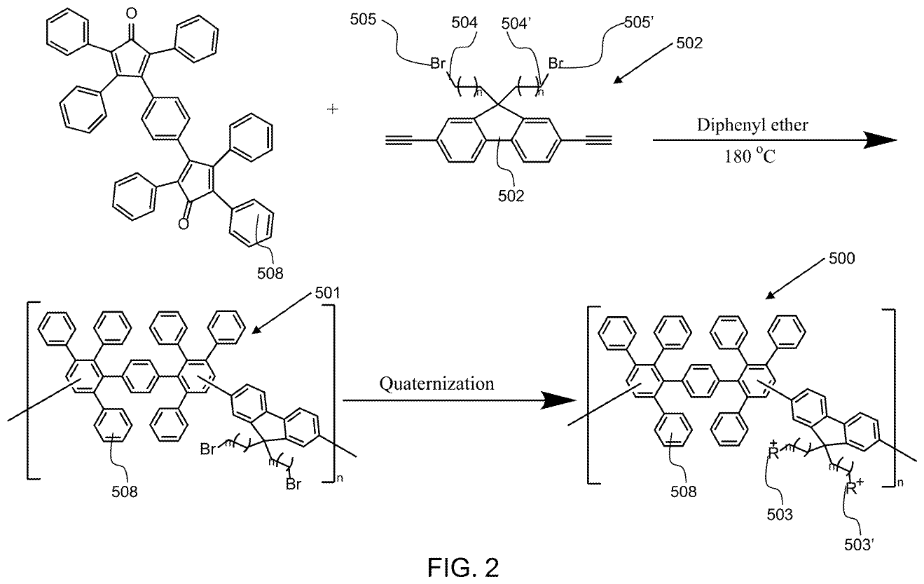

As shown in FIG. 1 and FIG. 2, an anion conducing co-polymer 500 includes a poly(fluorene) and poly(phenylene) structures deriving from the compound 502 and the compound 508, wherein the fluorene-based compound 502 has sidechains 504, 504′ that extend to a respective terminal group 505, 505′ that can be reacted to produce a functional group 503, 503′. FIG. 1 shows a polymer diagram of an ion conducting co-polymer 500 having a poly(fluorene) deriving from fluorene-based compound 502 and a poly(phenylene) deriving from the aromatic compound 508 covalently bonded to the poly(fluorene) compound. The fluorene-based compound is a polycyclic aromatic with a center with five carbons and two benzene rings on either side of said center ring. The compound has a pair of sidechains 504, 504′ that each extend to a respective terminal group 505, 505′, such as bromine, which can be functionalized with a functional group (R), 503, 503′ such as quaternary ammonium or n-methyl piperidine.

FIG. 2 shows a synthetic route for producing the ion conducting co-poly(phenylene-fluorene).

The aromatic monomer 508 shown in the FIG. 2 was synthesized according to previous literature. 1,4-bisbenzil (7.10 g) and 1,3-(diphenyl)propan-2-one (9.15 g) were combined in ethanol/toluene (10:1) mixture solvent and stirred at 70° C. until the solution is clear. Then, KOH (1.45 g) dissolved in methanol was added dropwise to the reaction solution and refluxed at 130° ° C. for 45 minutes. The reaction mixture was stored at 0° C. for 2 hours and resulting black-purple solids were filtrated and washed with ethanol and water for three times. The crude samples were purified through recrystallization in dichloromethane and dried at 80° C. under vacuum for overnight.

The fluorene-based compound 502 shown in the FIG. 2 was synthesized according to previous literatures. A general method is shown below, 2,7-dibromofluorene (1.62 g), trimethylsilylacetylene (4.9 g), Pd(PPh₃)₄ (0.58 g) and CuI (0.10 g) were mixed in the mixture solvent containing 30 ml THF and 10 m diisopropylamine under Argon. The reaction was stirred at 75° C. for 24 hours and the filtrate was concentrated under vacuum to give crude product, which was purified by flash column chromatography. The pure solids obtained was added in to THF/methanol (1:1) solvent containing potassium carbonate and stirred at room temperature overnight. The suspension was filtered and concentrated by rotary evaporation, which gives yellow solids of the product. The yellow solids were then mixed with tetrabutylammonium iodide, 1,6-dibromohexane in 50% KOH aqueous solution at 75° C. for 15 minutes. The mixture was extracted with dichloromethane and purified by flash column chromatography to give pure intermediate 502.

Details of a process for synthesizing the target precursor copolymer 501 shown in FIG. 2 are presented in Example 1.

### Example 1

Synthesis of the target precursor co-polymer 501 shown in FIG. 2. For the synthesis, a 100 ml three-neck flask was added with a mixture of the intermediate 508 bis (10.0 g) and intermediate 502 (7.82 g) in a 100 mL three-neck round bottom flask, diphenyl ether (50 mL) was added and the mixture was degassed three times. Then the mixture was heated at 180° C. for 24 h. The reaction vessel was then cooled to room temperature and its contents were precipitated in 10-fold methanol to give the precursor co-polymer 501.

The solution of precursor co-copolymer 501 in toluene was applied for casting a membrane on glass plate, the resulting film was then immersed in trimethylamine or N-methylpiperidine aqueous solution for 48 hours to functionalize the terminal groups of the sidechains to produce the ion conducting co-polymer.

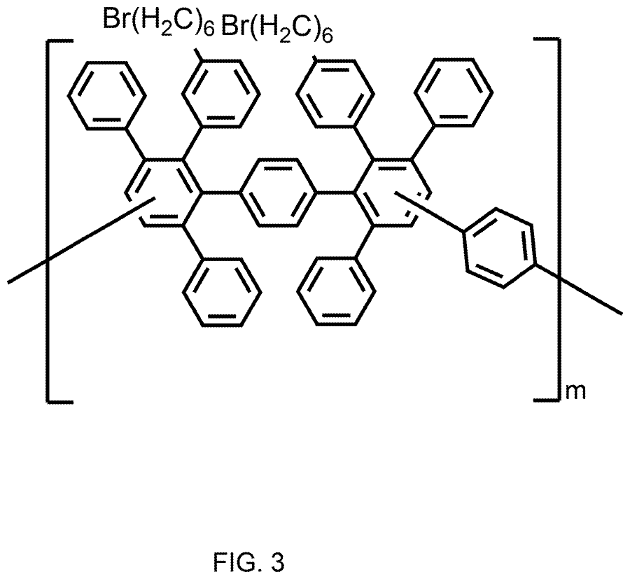

As shown in FIG. 3, a starting co-polymer includes a poly(phenylene) backbone structure. The backbone is a fully aromatic backbone, with no hydrocarbon, no aliphatic hydrocarbon chains. The backbone consists of benzene rings and the backbone is branched.

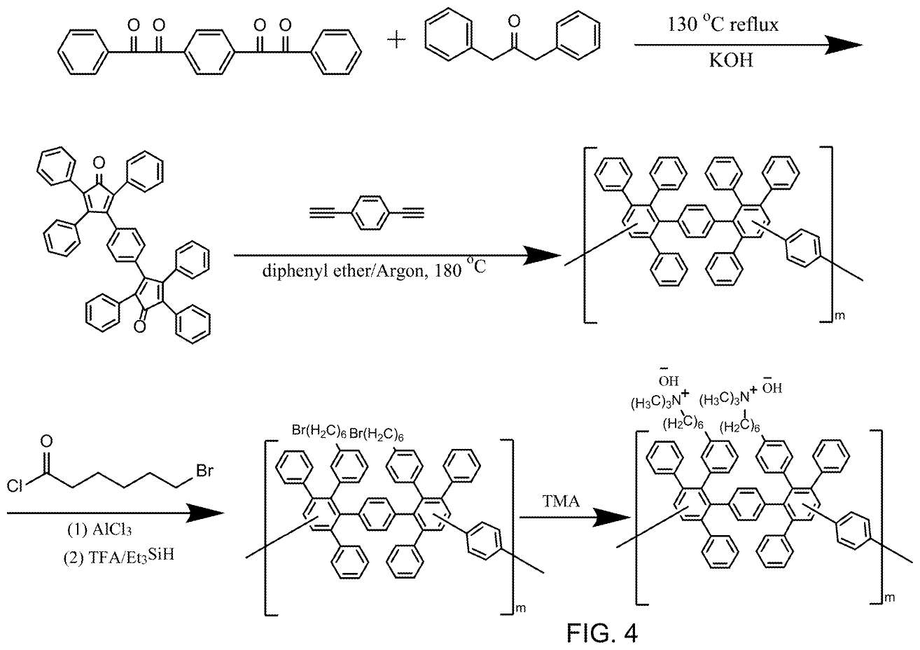

The aromatic monomer shown in the FIG. 4 was synthesized according to previous literature. 1,4-bisbenzil (7.10 g) and 1,3-(diphenyl)propan-2-one (9.15 g) were combined in ethanol/toluene (10:1) mixture solvent and stirred at 70° C. until the solution is clear. Then, KOH (1.45 g) dissolved in methanol was added dropwise to the reaction solution and refluxed at 130° C. for 45 minutes. The reaction mixture was stored at 0° C. for 2 hours and resulting black-purple solids were filtrated and washed with ethanol and water for three times. The crude samples were purified through recrystallization in dichloromethane and dried at 80° C. under vacuum for overnight.

Details of a process for synthesizing the copolymer 501 shown in FIG. 2 are presented in Example 2.

### Example 2

Bis-tetracyclone (50.0 g; 72.4 mmol) and 1,4-diethynylbenzene (9.13 g; 72.4 mmol) in a 500 mL Schlenk flash, diphenyl ether (250 mL) was added and the resulting mixture was frozen in an ice bath. The mixture is freeze-thaw degassed (3 times) before heating under argon (1 atm) at 180° C. for 24 h. Periodically, carbon monoxide was vented to avoid over-pressurization of the reaction flask. Subsequently, additional diethynylbenzene (0.10 g; 0.8 mmol) is added to the viscous slurry and the mixture was stirred for an additional 12 h at 180° C. The reaction vessel was then cooled to room temperature and its contents were diluted with toluene (300 mL). The polymer was precipitated by dropwise addition of the solution to 1000 mL of acetone. This dilution in toluene and precipitation in acetone was repeated and the resultant white solid was dried in a vacuum oven for 12 h at 80° C., 48 h at 230° C., and 24 h at room temperature. The polymer synthesized above (1.73 g, 2.28 mmol) was dissolved in dichloromethane (110 mL) in a flask under argon. The flask was chilled in an ice/water bath and 6-bromohexanoyl chloride (0.80 mL, 5.35 mmoles) was added. Aluminum chloride was added to the flask, the bath was removed, and the reaction was allowed to warm to room temperature over 5 hours while stirring. The solution was poured into a beaker containing 200 mL deionized water and the beaker was heated to 60° C. to evaporate the organic Solvent. After cooling to room temperature, the mixture was filtered and the solid was blended with acetone in a Waring blender. The mixture was filtered and the solid was dried at room temperature under vacuum to yield the polymer with a bromohexonyl side chain/functional group. To a solution of the polymer with side chain (1.50 g, 1.16 mmol)) in chloroform (40 mL) was added trifluoroacetic acid (20 mL) and triethylsilane (1.90 mL, 11.91 mmol). The solution was heated to reflux for 24 hours, then cooled to room temperature and poured into a beaker containing NaOH (9.6 g) dissolved in water (300 mL). The beaker was heated to 60° C. to evaporate the organic solvent. After cooling to room temperature, the mixture was filtered and the solid was blended with acetone in a Waring blender. The mixture was filtered and the solid was dried at room temperature under vacuum. Analysis of this product indicated incomplete reduction of the ketone, so the Solid was dissolved again in chloroform (40 mL) and trifluoroacetic acid (20 mL) and triethylsilane (1.90 mL, 11.91 mmol) were added. The solution was heated to reflux for 24 hours, then cooled to room temperature and poured into a beaker containing NaOH (9.6 g) dissolved in water (300 mL). The beaker was heated to 60° C. to evaporate the organic solvent. After cooling to room temperature, the mixture was filtered and the solid was blended with acetone in a Waring blender. The mixture was filtered and the solid was dried at room temperature under vacuum to yield final polymer as a white solid.

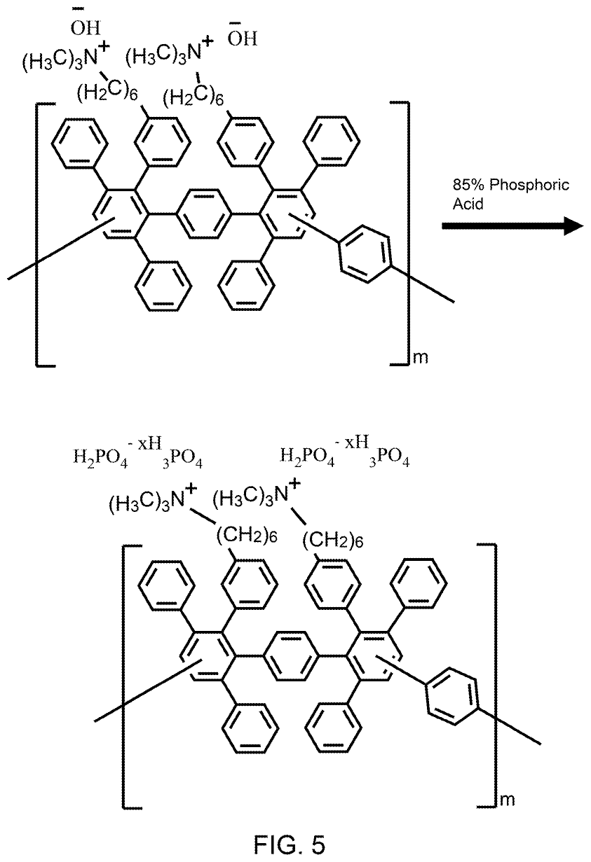

Details of a process for synthesizing the covalently phosphoric acid doping polymer shown in FIG. 5, are presented in Example 3.

### Example 3

The precursor polymer was casted to membranes by solution casting method and converted to OH form in NaOH solution for 12 hours. The preparation of phosphoric acid doped ion pair ion exchange membrane shown in FIG. 3 was conducted in 85 wt % phosphoric acid. The starting ion exchange membrane in OH form prepared above was transferred and soaked in 85 wt % phosphoric acid for 12 hours. Then the phosphoric acid doped ion exchange membrane was taken out of the phosphoric acid bath for drying for 72 hours.

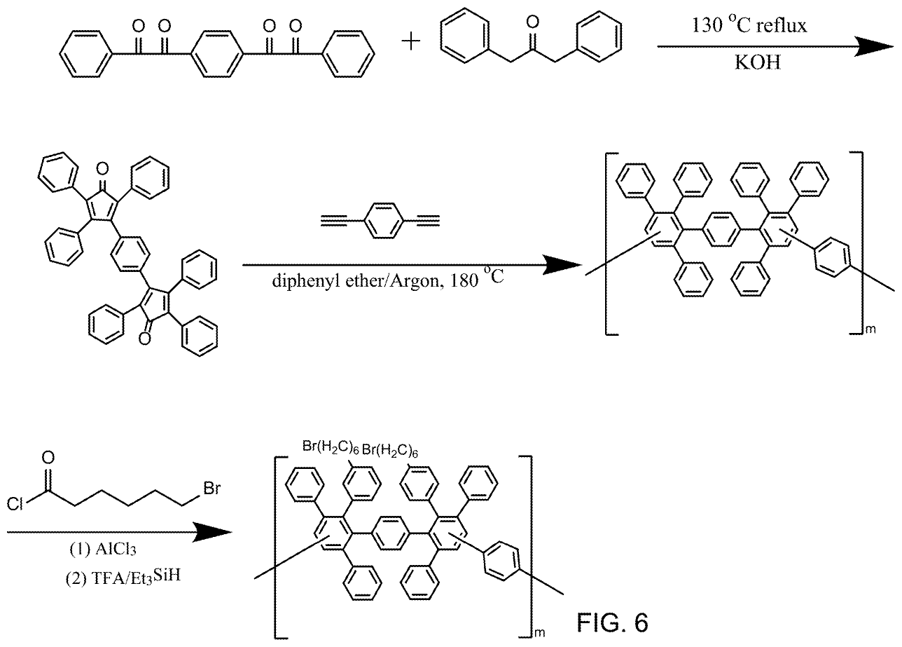

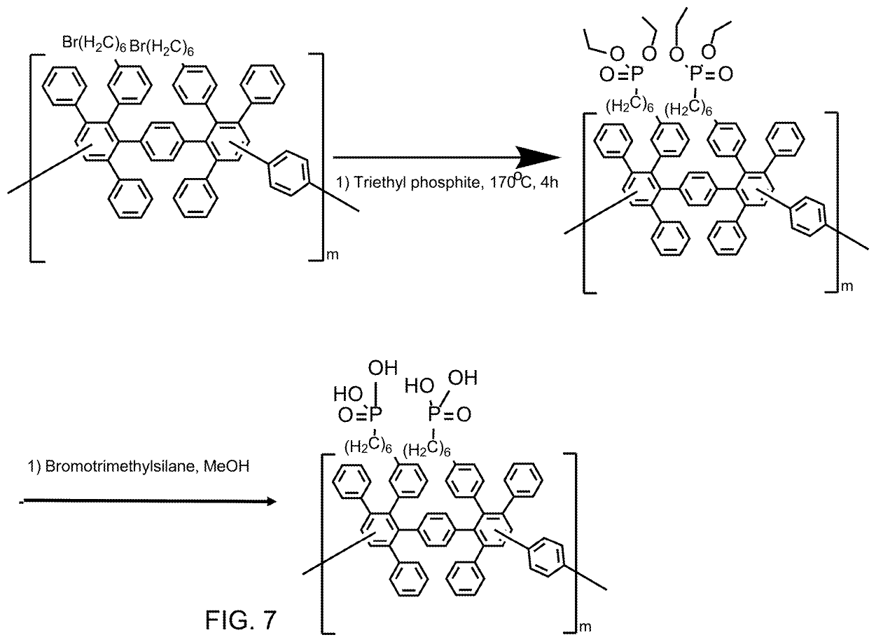

Referring now to FIG. 6 and FIG. 7. The aromatic monomer shown in the FIG. 6 was synthesized according to previous literature. 1,4-bisbenzil (7.10 g) and 1,3-(diphenyl)propan-2-one (9.15 g) were combined in ethanol/toluene (10:1) mixture solvent and stirred at 70° C. until the solution was clear. Then, KOH (1.45 g) dissolved in methanol was added dropwise to the reaction solution and refluxed at 130° C. for 45 minutes. The reaction mixture was stored at 0° C. for 2 hours and resulting black-purple solids were filtrated and washed with ethanol and water for three times. The crude samples were purified through recrystallization in dichloromethane and dried at 80° C. under vacuum for overnight.

As shown in FIG. 7, the covalent acid doping pathway is shown to produce the ion exchange co-poly(phenylene).

Details of a process for synthesizing the covalently phosphoric acid doping polymer shown in FIG. 7 are presented in Example 4.

### Example 4

The precursor was dispersed in triethyl phosphite, and refluxed at 170° C. for 4 hours under inert atmosphere. Excessive triethyl phosphite was evaporated under reduced pressure. To the obtained solid was added dichloromethane and bromotrimethylsilane dropwise. The resulting solution was stirred for 12 hours at room temperature after the addition. The solvent then was removed and methanol was added to the mixture for keeping stirring for 12 hours. Removing the methanol and washing the resulting polymer solid with water for three times.

According to one embodiment, a synthetic route and a composition are disclosed. The composition shown in Formula I includes the co-polymer structures with poly(phenylene) compounds integrated with functionalized poly(fluorene) compound. Where n is selected from 1-6 and R is selected from trimethylamine or N-methylpiperidine.

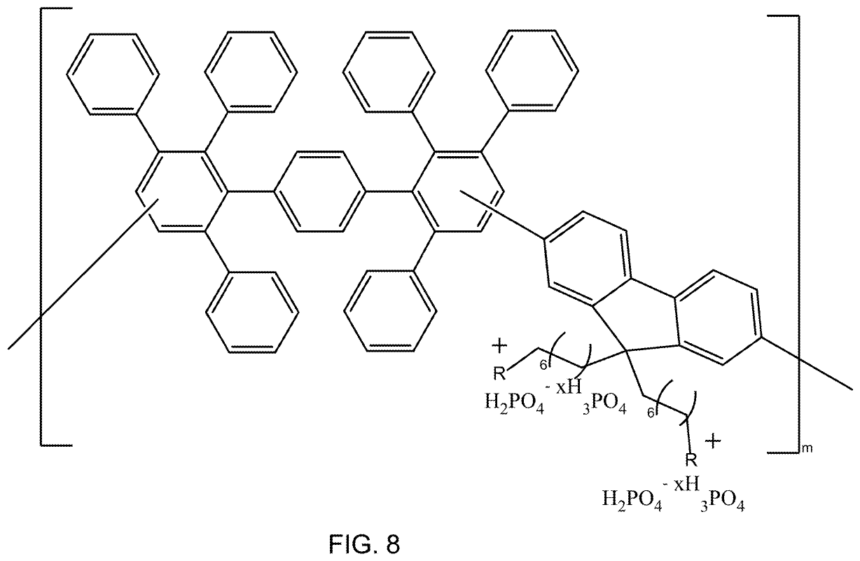

As shown in FIG. 8, ion pair acid doping produces phosphonic acid groups that are ionically bonded to the side chains of the fluorene of the co-poly(phenylene)-(fluorene).

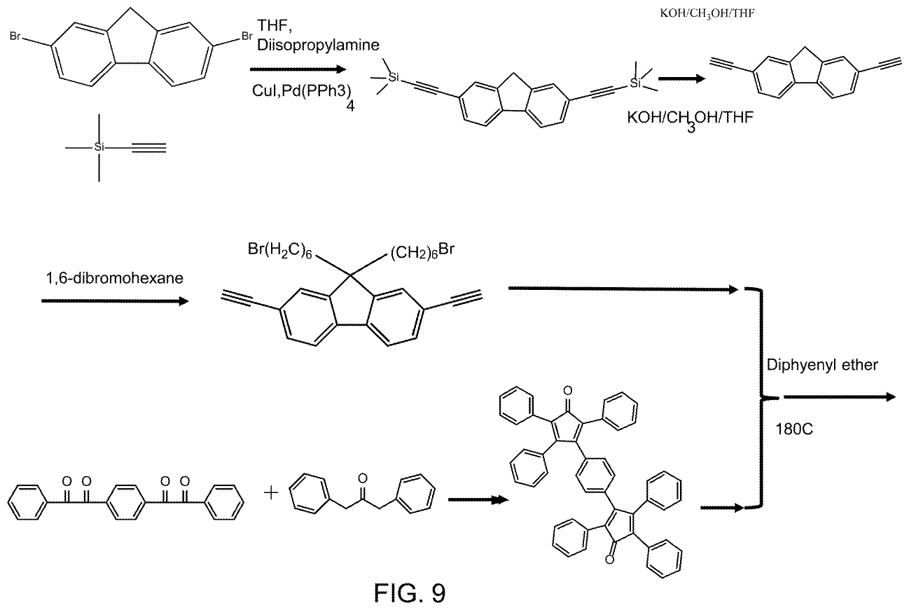

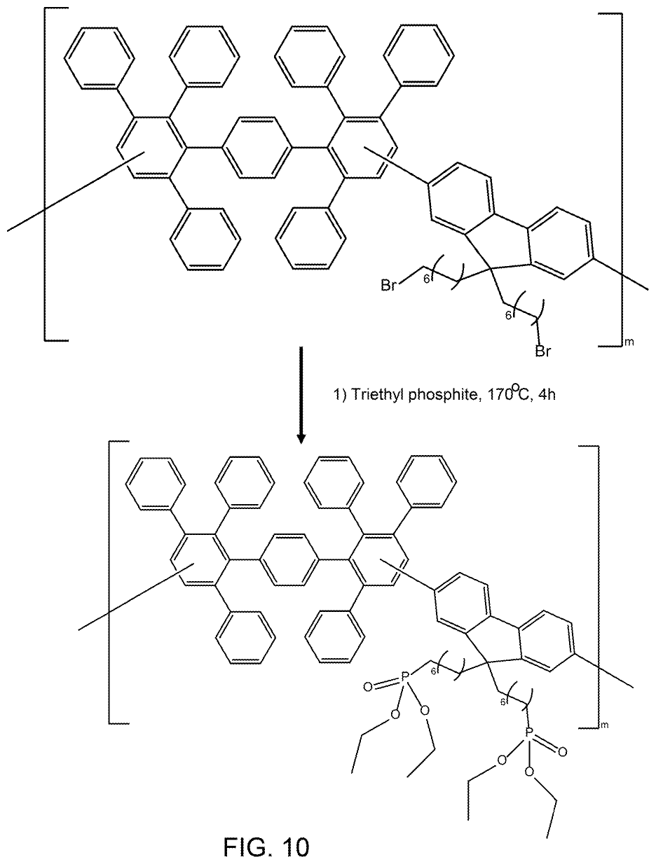

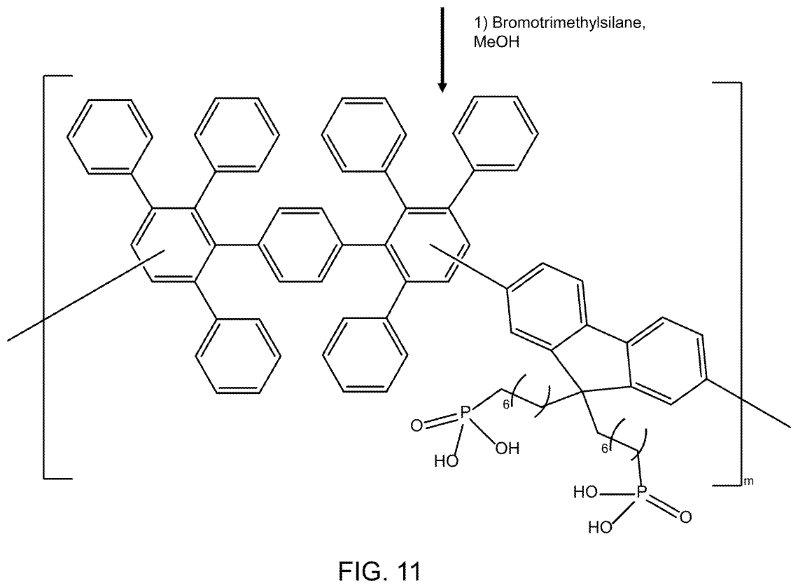

Referring now to FIGS. 9 to 11. FIG. 9 shows the synthetic route of the starting materials for synthesizing co-poly(phenylene-fluorene). FIG. 10 shows the covalent phosphoric acid-doping route of conductive co-poly(phenylene-fluorene). FIG. 11 shows an exemplary ion conducting co-polymer, co-poly(phenylene-fluorene) as described herein having covalently bonded phosphate.

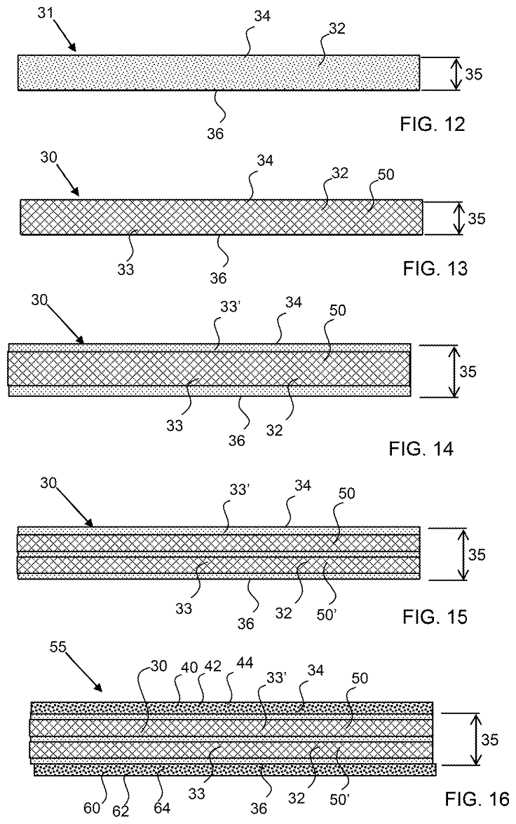

As shown in FIG. 12, an ion exchange membrane 31 is a planar thin layer of ion exchange polymer 32 having a planar first side 34 and second side 36, wherein the first side and second side extend in parallel to produce a substantially uniform thickness of the ion exchange membrane, with variations in thickness of no more than about 35% and preferably no more than 25% or even 10%.

As shown in FIG. 13, the ion exchange polymer 32 may be configured in a composite ion exchange membrane 30 has a support layer 33 and with ion exchange polymer 32 extending through the pores 50 from a first side 34 or anode side, to a second side 36 or cathode side. The thickness 35 of the composite ion exchange membrane 30 may be about 200 μm or less, about 150 μm or less, about 100 μm or less, about 50 μm or less, about 30 μm or less, about 25 μm or less, about 15 μm or less, about 10 μm or less, or even 5 μm or less.

As shown in FIG. 14, a composite ion exchange membrane 30 has a support layer 33 with ion exchange polymer 32 extending through the pores 50 of the support layer from a first side to a second side 36 of the support layer. Also, there is a layer of ion exchange polymer extending on the anode and cathode side, or first 34 and opposing second side of the composite ion exchange membrane 30. The thickness 35 of the composite ion exchange membrane 30 may be 50 μm or less, about 30 μm or less, about 25 μm or less, about 15 μm or less, about 10 μm or less, or even 5 μm or less. The proton exchange polymer 32 may be configured on just one side of a support layer 33, or may be only with the support layer or on one side and within at least partially the support layer.

As shown in FIG. 15, a composite ion exchange membrane 30 has a plurality of support layers 33 and 33′ and with ion exchange polymer 32 extending through the pores 50, 50′ of each layer from a first side to a second side 36 of each support layer. Also, there is a layer of ion exchange polymer extending on the anode and cathode side, or first 34 and opposing second side of the composite ion exchange membrane 30. The thickness 35 of the composite ion exchange membrane 30 may be 50 μm or less, about 30 μm or less, about 25 μm or less, about 15 μm or less, about 10 μm or less, or even 5 μm or less.

As shown in FIG. 16, the composite ion exchange membrane 30 may be incorporated into a membrane electrode assembly 55, having an anode 40 and cathode 60 on an opposing side of the composite ion exchange membrane 30. The anode may comprise an anode catalyst 42 and may also include an anode ion exchange polymer 44, which may be the same or different from the ion exchange polymer in the composite ion exchange membrane 30 or ion exchange membrane. Likewise, the cathode may comprise a cathode catalyst 62 and may also include an anode ion exchange polymer 64, which may be the same or different from the ion exchange polymer in the composite ion exchange membrane 30 or ion exchange membrane.

It will be apparent to those skilled in the art that various modifications, combinations, and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. An ion conducting co-polymer comprising:
a) a polymeric backbone comprising repeat units of a (phenylene) compound covalently bonded directly to a (fluorene) compound to produce co-poly(phenylene)-(fluorene);
wherein the (phenylene) compound comprises benzene rings;
wherein the benzene rings produce steric hinderance of the ion conducting co-polymer;
wherein said (fluorene) compound has a 9H-fluorene structure that is a polycyclic aromatic hydrocarbon having a center ring with five carbon atoms, and a benzene ring on each of opposing sides of said center ring; and a pair of sidechains extending from the center ring to a respective terminal group; and
wherein said (phenylene) compound is covalently bonded to each of said benzene rings of the (fluorene) compound;
b) two side chains extending from the (fluorene) compound; and
c) functional groups.

2. The ion conducting co-polymer of claim 1, wherein the ratio of the (fluorene) compound concentration to the (phenelyne) structure concentration is 1:1.

3. The ion conducting co-polymer of claim 1, wherein the benzene rings of the (phenelyne) compound are branched.

4. The ion conducting co-polymer of claim 1, wherein the (phenelyne) compound consists of benzene rings and has no aliphatic hydrocarbons.

5. The ion conducting co-polymer of claim 4, wherein the (phenelyne) compound has nine benzene rings.

6. The ion conducting co-polymer of claim 4, wherein the benzene rings of the (phenelyne) compound are branched.

7. The ion conducting co-polymer of claim 1, wherein each of the sidechains includes at least four carbons.

8. The ion conducting co-polymer of claim 1, wherein each of the sidechains is a hydrocarbon.

9. The ion conducting co-polymer of claim 1, wherein each of the sidechains comprises alkyl halides.

10. The ion conducting co-polymer of claim 1, wherein the functional groups include quaternary ammonium.

11. The ion conducting co-polymer of claim 1, wherein the functional groups include n-methyl piperidine.

12. The ion conducting co-polymer of claim 1, wherein the functional groups include phosphate that is covalently bonded to the side chain.

13. The ion conducting co-polymer of claim 1, further comprising a radical scavenger that is an antioxidant selected from the group consisting of Cerium (Ce), Manganese (Mn), phenolic compounds, nitrogen-containing heterocyclic compounds, quinones, amine, phosphites, phosphonites, and thioesters.

14. The ion conducting co-polymer of claim 1, further comprising a filler, wherein the filler is a hygroscopic inorganic filler.

15. The ion conducting co-polymer of claim 14, wherein the filler is a carbon-based materials selected from the group consisting of oxides of aluminum, silicon, titanium, zirconium and zirconium phosphate, cesium phosphate, zeolites, clays and carbon black, multiwall carbon nanotubes, reduced graphene oxide.

16. The ion conducting co-polymer of claim 1, further comprising a crosslinking agent that includes a tertiary diamine head groups which include DABCO (1,4-diazabicyclo[2,2,2]octane) and TMHDA (N,N,N,N-tetramethylhexane diammonium), 1,4-diiodobutane.

17. An ion exchange membrane comprising:
a) a support layer; and
b) the ion conducting co-polymer of claim 1;
wherein a thickness of the ion exchange membrane is no more than 100 μm.

18. The ion exchange membrane of claim 17, wherein the support layer comprises a porous polymer is selected from the group consisting of polyolefins, polyamides, polycarbonates, cellulosics, polyacrylates, copolyether esters, polyamides, polyarylether ketones, polysulfones, polybenzimidazoles, fluoropolymers, and chlorinated polymers.

19. The ion exchange membrane of claim 17, further comprising a plasticizer selected from the group consisting of nylon 6,6, Glycerol, ionic liquids and wherein the plasticizer is coupled to the support layer.

20. The ion exchange membrane of claim 17, further comprising a filler, wherein the filler is a hygroscopic inorganic filler selected from the group consisting of oxides of aluminum, silicon, titanium, zirconium and zirconium phosphate, cesium phosphate, zeolites, clays and carbon black, multiwall carbon nanotubes, reduced graphene oxide.
